(19) United States
(12) Patent Application Publication
(10) Pub. No.: US 2012/0117561 A1
(43) Pub. Date: May 10, 2012

(54) METHOD AND SERVER FOR APPLICATION SERVICE IN HOME NETWORK SYSTEM

(75) Inventors: Yun Ju LEE, Seoul (KR); Seok Pil LEE, Seongnam-si (KR); Tae Beom LIM, Yongin-si (KR); Kyung Won KIM, Seoul (KR); Jae Won MOON, Seoul (KR)

(73) Assignee: KOREA ELECTRONICS TECHNOLOGY INSTITUTE, Seongnam-si (KR)

(21) Appl. No.: 13/013,570

(22) Filed: Jan. 25, 2011

(30) Foreign Application Priority Data
Nov. 4, 2010 (KR) 10-2010-0109305

(51) Int. Cl. G06F 9/445

(52) U.S. Cl. 717/178

(57) ABSTRACT

Disclosed are a method and a server for application service in a home network. An application service method in a home network system according to an exemplary embodiment of the present invention includes: receiving characteristic information of the terminals and application requests from the terminals; downloading an integrated document including a plurality of components in response to the application requests; generating the application corresponding to each of the terminals by selecting and extracting at least some components from the integrated document according to the characteristic information; and providing the generated application to the corresponding terminal.

### CROSS-REFERENCE TO RELATED APPLICATIONS

This application claims priority under 35 U.S.C. §119 to Korean Patent Application No. 10-2010-109305, filed on Nov. 4, 2010, in the Korean Intellectual Property Office, the disclosure of which is incorporated herein by reference in its entirety.

### TECHNICAL FIELD

The present invention relates to a method and a server for application service in a home network system.

### BACKGROUND

As technological preparations for a mobile IPTV service through a mobile communication network is started and a wired/wireless IPTV convergence service is prepared, Scalable Video Coding (SVC) standardizes the encoding of a high-quality video for providing scalability to various terminals and detailed technological development is in progress. However, standardization or research for providing scalability for an application program is unprepared in an IPTV broadcast environment.

In the current IPTV service, since the service is provided to the terminal having the same performance specification, contents (media and application programs) optimized for the terminal performance specification may be provided. Thus, a service provider needs to separately converts/stores contents to be suitable for the specification of each terminal in order to provide the service to multiple terminals at the same time, which makes the service and maintenance costs a lot.

For example, when web browsing is performed in a mobile phone having a small display screen, Internet portal service providers such as NAVER, Daum, etc. allow users to access web pages prepared in advance to be suitable for the mobile phone. NAVER has a different URL (m.naver.com) for a mobile device having a small display screen, and Google verifies a version and an ID of a browser and transfers a web page corresponding to the version and ID. The reason is that a markup language technology cannot be applied to both a PC and a mobile device environment.

A World Wide Web consortium (W3C) is driving context information expression standardizations such as a device independent authoring language (DIAL), a content selection for device independence (DISelect), and delivery context interfaces (DCI) in addition to a composite capability/preference profile (CC/PP) to use a web application in various devices seamlessly. However, it is not sufficiently realized to provide a commercial use.

### SUMMARY

An exemplary embodiment of the present invention provides an application service method for providing an application suitable for each of a plurality of terminals in a home network system, the method including: receiving characteristic information of the terminals and application requests from the terminals; downloading an integrated document including a plurality of components in response to the application requests; generating the application corresponding to each of the terminals by selecting and extracting at least some components from the integrated document according to the characteristic information; and providing the generated application to the corresponding terminal.

The integrated document may be generated with a markup language which integrates components to present the application for each of the plurality of terminals.

The generating may includes: extracting a parameter from the characteristic information; determining a class corresponding to the terminal using the parameter; and selecting and extracting at least some components from the integrated document using the determined class.

The characteristic information may include at least one of a performance of the terminal, a resolution of the terminal, a bandwidth of the terminal, a location of terminals, a time of an area where the terminal is positioned, user information of the terminal, a security setting level of the terminal, and a constraint of the application.

The generating may further include generating the application by editing the components of the integrated document or adding other components using the determined class or the characteristic information.

Another exemplary embodiment of the present invention provides a server for providing an application suitable for each of a plurality of terminals in a home network system, the server including: a request processing unit receiving application requests and characteristic information of the terminals from the terminals; a client performance storing unit determining and storing a class corresponding to each terminal on the basis of the characteristic information; an application loader downloading an integrated document including a plurality of components in response to the application request; and a transcoding engine generating the application corresponding to each terminal by selecting and extracting at least some components from the integrated document by using the determined class.

The client performance storing unit may extract a parameter associated with the performance of the terminal from the characteristic information and determine a class of the terminal using the parameter.

The request processing unit may inquire the class corresponding to the terminal of the client performance storing unit, provide information regarding the corresponding class to the transcoding engine according to the inquiry result, and request downloading the integrated document by providing information regarding the application request to the application loader.

The transcoding engine may generate the application by editing the components of the integrated document or adding other components by using the determined class or the characteristic information.

Other features and aspects will be apparent from the following detailed description, the drawings, and the claims.

### BRIEF DESCRIPTION OF THE DRAWINGS

FIG. 1 is an exemplary diagram for describing a sharing method of contents in a home network system according to an exemplary embodiment of the present invention;

FIGS. 2 and 3 are flowcharts for describing a sharing method of contents in a home network system according to an exemplary embodiment of the present invention;

FIG. 4 is a conceptual diagram for describing a servicing method of an application in a home network system according to another exemplary embodiment of the present invention;

FIG. 5 is a flowchart for describing a servicing method of an application in a home network system according to another exemplary embodiment of the present invention;

FIG. 6 is an exemplary diagram showing a server of FIG. 4;

FIG. 7 is a conceptual diagram for describing a sharing method of an application in another home network system according to yet another exemplary embodiment of the present invention; and

FIG. 8 is a flowchart for describing a sharing method of an application in another home network system according to yet another exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

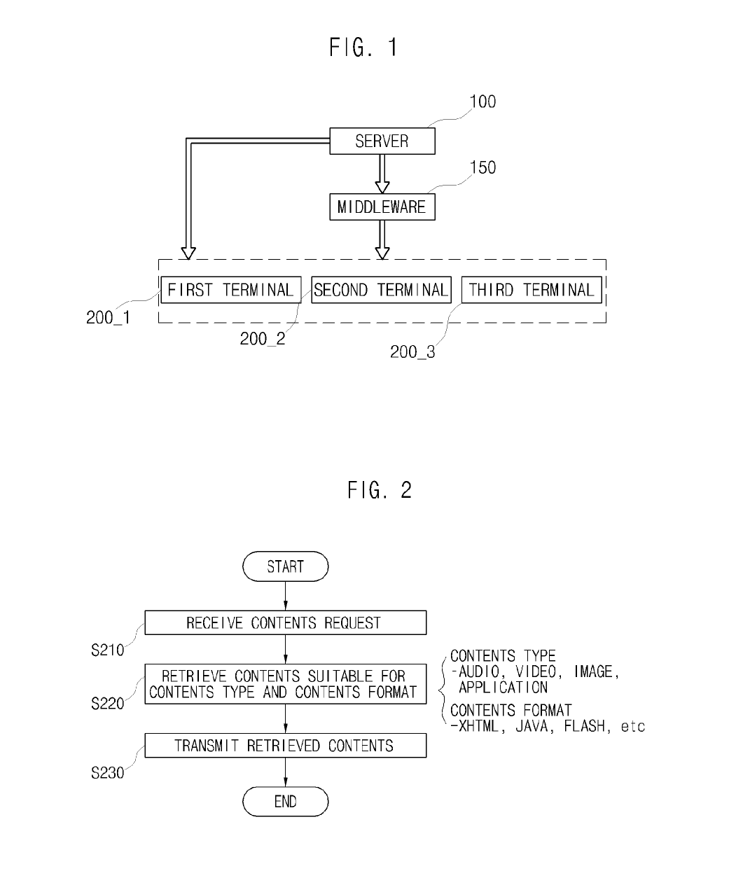

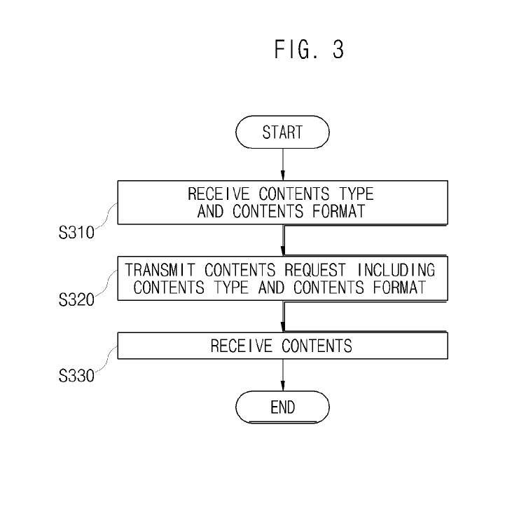

A sharing method of contents in a home network system according to an exemplary embodiment of the present invention will be described with reference to FIGS. 1 to 3. FIG. 1 is an exemplary diagram describing a sharing method of contents in a home network system according to an exemplary embodiment of the present invention and FIGS. 2 and 3 are flowcharts for describing a sharing method of contents in a home network system according to an exemplary embodiment of the present invention.

Referring to FIG. 1, the home network system performing the sharing method of contents according to the exemplary embodiment of the present invention includes a server 100, a middleware 150, and a plurality of terminals 200_1, 200_2, and 200_3.

The plurality of terminals 200_1, 200_2, and 200_3 may be various digital devices at home. For example, the terminals 200_1, 200_2, and 200_3 may be mobile devices such as a smart phone, a PDA (Personal Digital Assistant), a cellular phone, a PCS (Personal Communication Service) phone, a hand-held PC, a GSM (Global System for Mobile), a WCDMA (Wideband CDMA) phone, a CDMA (Code Division Multiple Access) 2000 phone, and an MBS (Mobile Broadband System) phone, or a device for a PC such as a PC, a tablet PC, or the like or a device for TV such as an HD TV.

The plurality of terminals 200_1, 200_2, and 200_3 are connected with the server 100 through the middleware 150 in a home network system. However, the terminals are not limited thereto and may be connected with the server 100 without the middleware 150. The plurality of terminals 200_1, 200_2, and 200_3 request the contents to the server 100 or the server 100 through the middleware 150 and the server 100 provides the contents to each terminal 200_1, 200_2, or 200_3 to share the contents between the terminals 200_1, 200_2, and 200_3.

In detail, referring to FIGS. 2 and 3, the server 100 receives the content request from each terminal 200_1, 200_2, or 200_3 (S210). Herein, the content request may include at least one of information on a content type and information on a content format. For this, each terminal 200_1, 200_2, or 200_3 receives at least one of the information on a content type and the information on a content format from a user (S320) and transmits the content request including at least one of the information on a content type and the information on a content format (S320).

The server 100 retrieves the contents matching the information on a content type and the content format in the content request among the stored contents (S220). Herein, the content type may include at least one of audio, video, an image, and an application and the content format may include at least one of an XHTML, a JAVA, and a FLASH. Meanwhile, the content format is capable of further extending in the case of an object-oriented and describable application in addition to the XHTML, JAVA, and FLASH. That is, contents having a format agreed among the terminals 200_1, 200_2, and 200_3 or among the terminals 200_1, 200_2, and 200_3 and the server 100 may be requested. That is, the terminals 200_1, 200_2, and 200_3 may request the contents having any one format of the group which formats agreed among the terminals 200_1, 200_2, and 200_3 or among the terminals 200_1, 200_2, and 200_3 and the server 100 belong to.

In addition, the server 100 transmits the searched contents to the terminal 200_1, 200_2, and 200_3 transmitting the content request (S230) and each terminal 200_1, 200_2, or 200_3 receives the contents (S330).

Herein, the content request from the terminal 200_1, 200_2, and 200_3 to the server 100 may be transmitted through the middleware 150, or without the middleware 150. In addition, the contents transmission from the server 100 to the terminal 200_1, 200_2, and 200_3 may be transmitted through the middleware 150, or without the middleware 150.

As such, the plurality of terminals 200_1, 200_2, and 200_3 in the home network system can share an application as well as audio, video, and an image. Herein, the application may be any one of a graphic user interface (GUI) between each terminal 200_1, 200_2, or 200_3 and the server 100, an application program interlocked with the contents, and a GUI between each terminal 200_1, 200_2, or 200_3 and the middleware 150, for example. Accordingly, the application is capable of sharing the contents between the terminals 200_1, 200_2, and 200_3, between the server 100 and the terminals 200_1, 200_2, and 200_3, between the server 100 and the middleware 150, and between the middleware 150 and the terminals 200_1, 200_2, and 200_3.

Meanwhile, each of the terminals 200_1, 200_2, and 200_3 provides various viewing environments to the user according to the kinds thereof. Accordingly, when the server 100 services the contents to each terminal 200_1, 200_2, or 200_3, it may be considered that the server services the contents pertinent to be reproduced by each terminal. Hereinafter, a method capable of optimally reproducing according to each characteristic will be described while various terminals 200_1, 200_2, and 200_3 in the home network system share the contents. Further, the case where the terminals 200_1, 200_2, and 200_3 share the application among the various contents will be described as an example.

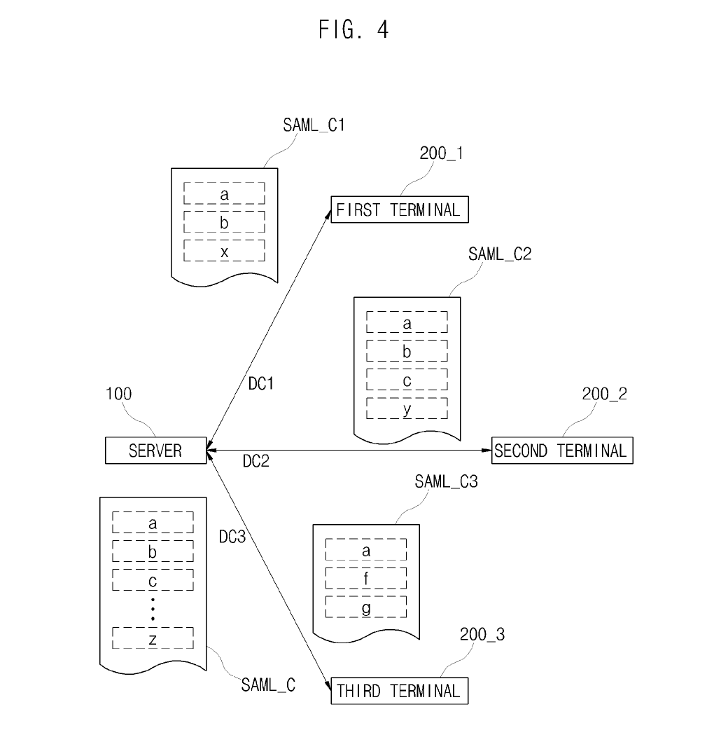

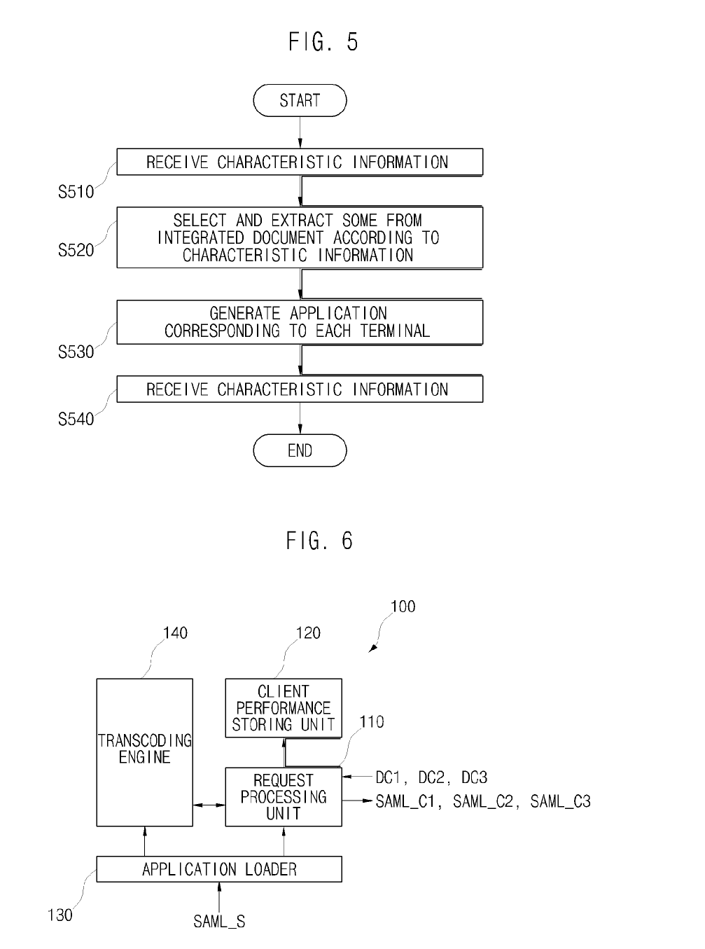

A servicing method of an application in a home network system according to another exemplary embodiment of the present invention will be described with reference to FIGS. 4 to 6. FIG. 4 is a conceptual diagram for describing a servicing method of an application in a home network system according to another exemplary embodiment of the present invention, FIG. 5 is a flowchart for describing a servicing method of an application in a home network system according to another exemplary embodiment of the present invention, and FIG. 6 is an exemplary diagram showing the server of FIG. 4.

First, referring to FIG. 4, a home network system performing a servicing method of an application according to another exemplary embodiment of the present invention includes a server 100 and a plurality of terminals 200_1, 200_2, and 200_3.

However, the home network system may further include a middleware 150 as shown in FIG. 1.

The server 100 is connected with the plurality of terminals 200_1, 200_2, and 200_3 to make it possible to control a contents sharing among the terminals 200_1, 200_2, and 200_3 and interworking among the terminals 200_1, 200_2, and 200_3. In addition, the server 100 provides applications SAML_C1, SAML_C2, and SAML_C3 having the same or similar function to each of the terminals 200_1, 200_2, and 200_3 properly according to a capability and a state, etc., of each of the terminals 200_1, 200_2, and 200_3, such that the application may be shared among the terminals 200_1, 200_2, and 200_3 providing various viewing environments.

Hereinafter, it will be described in more detail.

First, each of the terminals 200_1, 200_2, and 200_3 transmits their characteristic information DC_1, DC_2, or DC_3 to the server 100. Herein, the characteristic information DC_1, DC_2, or DC_3 means information of each terminal 200_1, 200_2, or 200_3 for being optimally expressed (or reproduced) in each terminal 200_1, 200_2, or 200_3 when the contents are provided from the server 100 to each terminal 200_1, 200_2, or 200_3. For example, the characteristic information DC_1, DC_2, or DC_3 may include at least one of a capability, a resolution, a processing capacity, a network factor, a supported language, a time, a position at home, a usable power level, and the like.

In addition, each terminal 200_1, 200_2, or 200_3 may request a desired content to the server 100. Herein, the contents may be various kinds or various formats of contents such as video, audio, and an image file. Hereinafter, a GUI (Graphic User Interface) or applications SAML_C1, SAML_C2, and SAML_C3 will be described as an example.

The server 100 receives characteristic information from each terminal 200_1, 200_2, or 200_3 (S510) and determines the characteristic information DC_1, DC_2, or DC_3 of each terminal 200_1, 200_2, or 200_3. In this case, the server 100 may receive the request of the applications SAML_C1, SAML_C2, and SAML_C3 from each terminal 200_1, 200_2, or 200_3.

In addition, the server 100 determines the characteristic information DC_1, DC_2, or DC_3 and provides the most optimized applications SAML_C1, SAML_C2, and SAML_C3 to be reproduced by each terminal 200_1, 200_2, or 200_3 according to each characteristic information DC_1, DC_2, or DC_3.

In detail, the server 100 may have an integrated document SAML_S made by a markup language. The integrated document SAML_S may be a document in which components (or items) a to z made up by the markup language are integrated so that each of the plurality of terminals 200_1, 200_2, and 200_3 can reproduce the optimized applications SAML_C1, SAML_C2, and SAML_C3. Accordingly, the server 100 selects and extracts at least one component from one integrated document SAML_S according to the characteristic information DC_1, DC_2, or DC_3 provided from each terminal 200_1, 200_2, or 200_3 (S520) and generates the application SAML_C1, SAML_C2, or SAML_C3 corresponding to the characteristic information DC_1, DC_2, or DC_3 provided from each terminal 200_1, 200_2, or 200_3 (S530). In addition, the server 100 services the optimized application SAML_C1, SAML_C2, or SAML_C3 to each terminal 200_1, 200_2, or 200_3 (S540). Herein, the application SAML_C1, SAML_C2, or SAML_C3 may be constituted by at least one of an XHTLM, an HTML, a JAVA, and a Flash.

For example, the server 100 may have the integrated document SAML_S constituted by a to z components. The server 100 receives first characteristic information DC_1 from a first terminal 200_1 and determines the characteristic information DC_1 to make it possible to recognize the resolution and the processing capability of the first terminal 200_1. In addition, the server 100 selects and extracts the components a, d, and x capable of being reproduced and processed in the resolution of the first terminal 200_1 from the integrated document SAML_S to make it possible to generate the application SAML_C1 constituted by the components a, d, and x and transmit it to the first terminal 200_1.

Further, the server 100 receives and determines second characteristic information DC_2 from a second terminal 200_2 to make it possible to recognize a supporting language, a usable bandwidth, a position in home, and the like of the second terminal 200_2. In addition, the server 100 selects and extracts the components a, b, c, and y capable of being reproduced and processed in the supporting language, the usable bandwidth, the position in home, and the like of the second terminal 200_2 from the integrated document SAML_S to make it possible to generate the application SAML_C2 constituted by the components a, b, c, and y and transmit it to the second terminal 200_2.

Further, the server 100 receives and determines third characteristic information DC_3 from a third terminal 200_3 to make it possible to recognize user information, a security setting degree, and the like of the third terminal 200_3. In addition, the server 100 selects and extracts the components a, f, and g capable of being reproduced and processed by the user information, the security setting degree, and the like of the third terminal 200_3 from the integrated document SAML_S to make it possible to generate the application SAML_C3 constituted by the components a, f, and g and transmit it to the third terminal 200_3.

As such, since the server 100 selects and extracts some components from one integrated document SAML_S so that each terminal 200_1, 200_2, or 200_3 optimally reproduces the applications SAML_C1, SAML_C2, and SAML_C3 according to characteristic of each terminal 200_1, 200_2, or 200_3, it is possible to share one application in an optimized state in each terminal 200_1, 200_2, or 200_3. Herein, the integrated document SAML_S is newly defined by the applicant of the invention, is made by the markup language, and the components corresponding to the characteristic information DC_1, DC_2, and DC_3 of all the terminals 200_1, 200_2, and 200_3 are integrated into one document. In addition, since the server 100 can select and extract at least some components from the integrated document SAML_S according to the characteristic information DC_1, DC_2, or DC_3 of each terminal 200_1, 200_2, or 200_3, that is, the integrated document SAML_S is scalable, hereinafter, the integrated document SAML_S is called an SAML (Scalable Application Markup Language) document.

Hereinafter, a method in which the server 100 effectively services the optimized applications SAML_C1, SAML_C2, and SAML_C3 to each terminal 200_1, 200_2, or 200_3 using the SAML document will be described in detail.

The server 100 determines the characteristic information DC_1, DC_2, or DC_3 received from each terminal 200_1, 200_2, or 200_3 and classifies each terminal 200_1, 200_2, or 200_3 into any one of the predetermined classes. For example, the server 100 classifies each terminal 200_1, 200_2, or 200_3 into any one class of a first class of base profile, a second class of a main profile, and a third class of a high profile. Herein, each class may be classified depending on the capability and/or the resolution of the terminals 200_1, 200_2, and 200_3. For example, the first class of base profile may correspond to a capability and a resolution of a mobile device, the second class of the main profile may correspond to a PC-class device, and the third class of the high profile may correspond to an HD TV-class device. The classifying criterion is an example and the criterion classifying each class may be variously set according to the home network system.

In addition, the SAML document SAML_S has the integrated components corresponding to each class. Accordingly, the server 100 classifies the class of each terminal 200_1, 200_2, or 200_3 according to the characteristic information DC_1, DC_2, or DC_3 received from each terminal 200_1, 200_2, or 200_3 and selects and extracts the components corresponding to the classified class from the integrated document SAML_S to service the applications SAML_C1, SAML_C2, and SAML_C3.

As such, the server 100 classifies each terminal 200_1, 200_2, or 200_3 into any one of predetermined classes and easily and effectively selects and extracts proper components based on the class in the SAML document SAML_S having the integrated components corresponding to each class.

Meanwhile, when the characteristic information DC_1, DC_2, and DC_3 are described in more detail, the characteristic information DC_1, DC_2, and DC_3 may include a device capability factor or an external viewing environment factor.

The device capability factor may include, for example, input-output devices factors of the terminals 200_1, 200_2, and 200_3, processing capability factors of the terminals 200_1, 200_2, and 200_3, network factors, and the like. The output device factors of the terminals 200_1, 200_2, and 200_3 may mean, for example, a screen resolution of the terminals 200_1, 200_2, and 200_3, a screen orientation such as a vertical orientation (portrait) or a horizontal orientation (landscape), an audio output capability such as mono or stereo. The input device factors of the terminals 200_1, 200_2, and 200_3 may mean kinds of a keyboard, a mouse touch screen, and the like. The processing capability factors a MIME type supportable by the terminals 200_1, 200_2, and 200_3, a script parser, a browser, a java virtual machine, a flash player, a caption format, a supportable DRM type, a supportable CAS type, and the like. The network factors may mean a supportable network interface unit, a usable bandwidth, a standby time, and the like. In addition, the network factors may include a supportable language, a time of an area in which the terminals 200_1, 200_2, and 200_3 are positioned, a position in home, a usable power level of the terminals 200_1, 200_2, and 200_3, and the like.

The external viewing environment factor of the terminals 200_1, 200_2, and 200_3 may mean factors for a viewing environment and a preferable taste and information of a user capable of having influence on representing the applications SAML_C1, SAML_C2, and SAML_C3 other than the device capability factor. For example, the external viewing environment factor may mean the viewing environment factor such as brightness, a temperature, a noise, and the like and the user information such as a user viewing environment information, a user age, a sex, a privacy, a limitation factor of the shared applications SAML_C1, SAML_C2, and SAML_C3, and the like.

According to the characteristic information DC_1, DC_2, and DC_3, the server 100 selects and extracts proper components from the SAML document SAML_S to service the applications SAML_C1, SAML_C2, and SAML_C3 corresponding to each characteristic information DC_1, DC_2, or DC_3.

Meanwhile, referring to FIG. 6, the server of FIG. 4 will be described in detail.

Referring to FIG. 6, the server 100 may include a request processing unit 110, a client capability storing unit 120, an application loader 130, and a transcoding engine 140.

First, the request processing unit 110 receives the content requests from the terminals 200_1, 200_2, and 200_3 and the characteristic information DC_1, DC_2, and DC_3 of the terminals 200_1, 200_2, and 200_3. The content requests and the characteristic information DC_1, DC_2, and DC_3 of the terminals 200_1, 200_2, and 200_3 may be transmitted through, for example, protocol http. In addition, the request processing unit 110 may inquire of the client capability storing unit 120 about classes to which the terminals 200_1, 200_2, and 200_3 belong by using the characteristic information DC_1, DC_2, and DC_3 of the terminals 200_1, 200_2, and 200_3. In addition, the request processing unit 110 provides the information on the classes provided by the inquiry result from the client capability storing unit 120 to the transcoding engine 140 to be described below to allow the transcoding engine 140 to generate the applications SAML_C1, SAML_C2, and SAML_C3 suitable for the terminals 200_1, 200_2, and 200_3, respectively. Further, the request processing unit 110 may provide the information on the content request to the application loader 130.

The client capability storing unit 120 receives the characteristic information DC_1, DC_2, and DC_3 from the request processing unit 110 to extract parameters from the characteristic information DC_1, DC_2, and DC_3 and determine the classes of the terminals 200_1, 200_2, and 200_3 by using the extracted parameters. Herein, the parameters represent the above-mentioned device capability factors and external environmental factors. That is, the client capability storing unit determines which class among a first class of a base profile, a second class of a main profile, and a third class of a high profile each of the terminals 200_1, 200_2, and 200_3 belongs to by using the parameters representing the device capability factors and external environmental factors, and provides the information on the corresponding class to the request processing unit. Further, the client capability storing unit stores information on the capability, the parameters or the characteristic information DC_1, DC_2, and DC_3, or the information on the class of each of the terminals 200_1, 200_2, and 200_3 in order to efficiently process the request from each terminal 200_1, 200_2, or 200_3. For example, when an ID of each of the terminals 200_1, 200_2, and 200_3 or user information of each of the terminals 200_1, 200_2, and 200_3, or the characteristic information DC_1, DC_2, or DC_3 of each terminal 200_1, 200_2, or 200_3 is provided, the client capability storing unit 120 may provide the class information of the terminals 200_1, 200_2, and 200_3 immediately to the request processing unit 110 on the basis of the provided ID of each of the terminals 200_1, 200_2, and 200_3 or user information of each of the terminals 200_1, 200_2, and 200_3, or characteristic information DC_1, DC_2, or DC_3 of each terminal 200_1, 200_2, or 200_3 without extracting the parameters.

The application loader 130 retrieves and downloads the requested contents, e.g., the SAML document for the requested applications SAML_C1, SAML_C2, and SAML_C3 by using the information on the content request. For example, the application loader 130 may retrieve and download the SAML document corresponding to the requested application among various SAML documents stored on the web. In addition, the application loader 130 provides the downloaded SAML document to the transcoding engine 140. If the server 100 already possesses the corresponding SAML document, the server 100 may provide its own SAML document to the transcoding engine 140 without retrieving the SAML document on the web.

The transcoding engine 140 selects and extracts at least some components from the SAML document SAML_S provided from the application loader 130 by using the class information and/or the characteristic information DC_1, DC_2, and DC_3 to generate the applications SAML_C1, SAML_C2, and SAML_C3 optimized for the terminals 200_1, 200_2, and 200_3. In addition, the transcoding engine 140 may provide the generated applications SAML_C1, SAML_C2, and SAML_C3 to the terminals 200_1, 200_2, and 200_3 through the request processing unit 110.

Meanwhile, the transcoding engine 140 may generate the applications SAML_C1, SAML_C2, and SAML_C3 by editing the component of the integrated document SAML_S or adding other components by using the class information and/or the characteristic information DC_1, DC_2, and DC_3.

That is, the server 100 generates the application SAML_C1, SAML_C2, or SAML_C3 suitable for each terminal 200_1, 200_2, or 200_3 and provides it to each terminal 200_1, 200_2, or 200_3. The server 100 stores and manages the application SAML_C1, SAML_C2, or SAML_C3 generated for each terminal 200_1, 200_2, or 200_3 and when the applications SAML_C1, SAML_C2, and SAML_C3 are requested afterwards, it is possible to improve the efficiency of the sharing service of the applications SAML_C1, SAML_C2, and SAML_C3 by providing the previously generated applications SAML_C1, SAML_C2, and SAML_C3 that are stored and managed. Furthermore, the server 100 manages the generated applications SAML_C1, SAML_C2, and SAML_C3 for each terminal and each terminal user on the basis of the user information to efficiently provide the application suitable for each terminal and for each user at the time of requesting the application.

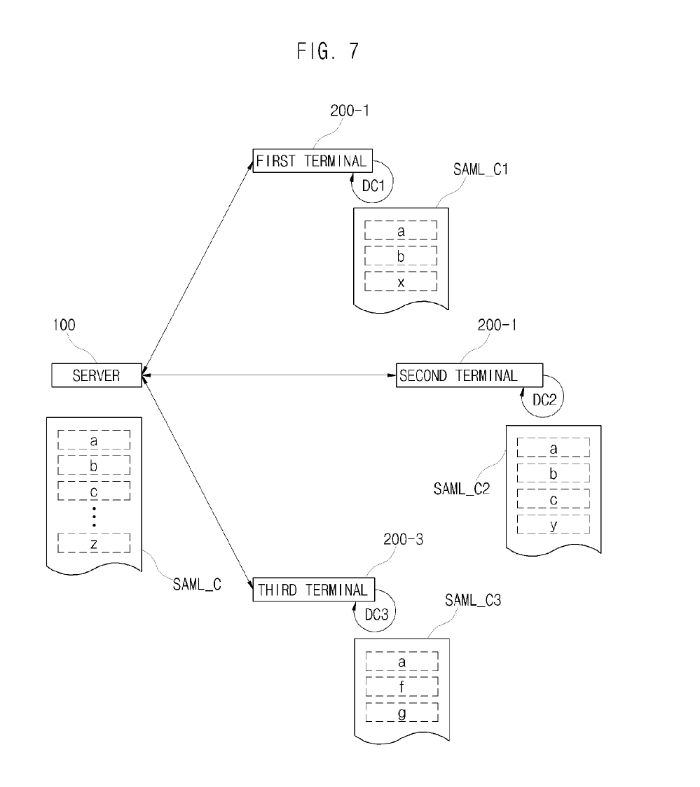

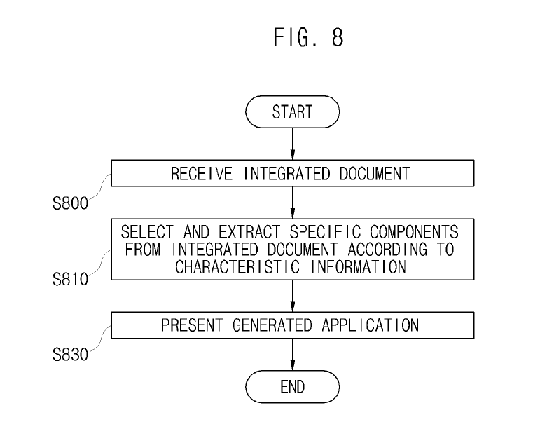

Hereinafter, referring to FIGS. 7 and 8, a sharing method of an application method in a home network system according to yet another exemplary embodiment of the present invention will be described. FIG. 7 is a conceptual diagram for describing a sharing method of an application in another home network system according to yet another exemplary embodiment of the present invention and FIG. 8 is a flowchart for describing a sharing method of an application in another home network system according to yet another exemplary embodiment of the present invention.

In the exemplary embodiment, the server 100 transmits one SAML document SAML_S to a plurality of terminals 200_1, 200_2, and 200_3 and each terminal 200_1, 200_2, or 200_3 selects and extracts some components from the received SAML document SAML_S according to its own characteristic information DC_1, DC_2, or DC_3 to generate and reproduce the application SAML_C1, SAML_C2, or SAML_C3 optimized for itself unlike the previous exemplary embodiment.

Referring to FIGS. 7 and 8, each terminal 200_1, 200_2, or 200_3 receives the SAML document SAML_S from the server 100 (S810). For example, each terminal 200_1, 200_2, or 200_3 requests the application SAML_C1, SAML_C2, or SAML_C3 to the server 100 and receives the SAML document SAML_S from the server 100 in response to the request.

In addition, each terminal 200_1, 200_2, or 200_3 selects and extracts at least some components from the SAML document SAML_S according to its characteristic information DC_1, DC_2, or DC_3 (S820) and generates the application SAML_C1, SAML_C2, or SAML_C3 optimized for itself. In addition, each terminal 200_1, 200_2, or 200_3 reproduces the generated application SAML_C1, SAML_C2, or SAML_C3 (S830).

According to exemplary embodiments of the present invention, by providing a scalable application markup language which is a context aware type scalable user interface on a home network in order to provide user interfaces and application programs optimized for terminals having different device capabilities in consideration of viewing environments, it is possible to share/interwork an application program in addition to video, audio, and an image file in an IPTV environment, apply digital apparatuses having different viewing environments at the same time, and improve user convenience and efficiently store/manage/use contents by providing a user interface optimized for various viewing environments.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An application service method for providing an application suitable for each of a plurality of terminals in a home network system, the method comprising:
receiving characteristic information of the terminals and application requests from the terminals;
downloading an integrated document including a plurality of components in response to the application requests;
generating the application corresponding to each of the terminals by selecting and extracting at least some components from the integrated document according to the characteristic information;
and providing the generated application to the corresponding terminal.

2. The application service method of claim 1, wherein the integrated document is generated with a markup language which integrates components to present the application for each of the plurality of terminals.

3. The application service method of claim 1, wherein the generating includes:
extracting a parameter from the characteristic information;
determining a class corresponding to the terminal using the parameter; and
selecting and extracting at least some components from the integrated document using the determined class.

4. The application service method of claim 3, wherein the characteristic information includes at least one of a performance of the terminal, a resolution of the terminal, a bandwidth of the terminal, a location of terminals, a time of an area where the terminal is positioned, user information of the terminal, a security setting level of the terminal, and a constraint of the application.

5. The application service method of claim 4, wherein the generating further includes generating the application by editing the components of the integrated document or adding another components using the determined class or the characteristic information.

6. A server for providing an application suitable for each of a plurality of terminals in a home network system, the server comprising:
a request processing unit receiving characteristic information of the terminals and application requests from the terminals;
a client performance storing unit determining and storing a class corresponding to each terminal on the basis of the characteristic information;
an application loader downloading an integrated document including a plurality of components in response to the application request; and
a transcoding engine generating the application corresponding to each terminal by selecting and extracting at least some components from the integrated document using the determined class.

7. The server of claim 6, wherein the client performance storing unit extracts a parameter associated with the performance of the terminal from the characteristic information and determines a class of the terminal using the parameter.

8. The server of claim 6, wherein the request processing unit inquires the class corresponding to the terminal of the client performance storing unit, provides information regarding the corresponding class to the transcoding engine according to the inquiry result, and requests downloading the integrated document by providing information regarding the application request to the application loader.

9. The server of claim 6, wherein the characteristic information includes at least one of a performance of the terminal, a resolution of the terminal, a bandwidth of the terminal, a location of terminals, a time of an area where the terminal is positioned, user information of the terminal, a security setting level of the terminal, and a constraint of the application.

10. The server of claim 6, wherein the transcoding engine generates the application by editing the components of the integrated document or adding another components using the determined class or the characteristic information.
